(19) United States
(12) Patent Application Publication
(10) Pub. No.: US 2006/0172055 A1
(43) Pub. Date: Aug. 3, 2006

(54) Food

(75) Inventor: Catherine Fryirs, Sydney (AU)

Correspondence Address: SUGHRUE MION, PLLC, 2100 PENNSYLVANIA AVENUE, N.W., SUITE 800, WASHINGTON, DC, 20037, US

(73) Assignee: GEORGE WESTON FOODS LIMITED

(21) Appl. No.: 11/333,419

(22) Filed: Jan. 18, 2006

Related U.S. Application Data
(63) Continuation of application No. 10/382,910, filed on Mar. 7, 2003, now abandoned.

(30) Foreign Application Priority Data
Mar. 8, 2002 (AU) PS0963

(51) Int. Cl. A23L 1/40

(52) U.S. Cl. 426/589

(57) ABSTRACT

Chemically cross-linked and/or substituted waxy wheat starch is described. The modified waxy wheat starch is stable to acid conditions between pH 3 and a pH less than 7, freeze/thaw stable and has a smooth and creamy mouthfeel. Food products containing the modified waxy wheat starch are also described.

### FIELD OF THE INVENTION

The present invention relates to food products, and in particular to a modified starch with improved properties.

### BACKGROUND OF THE INVENTION

Starch contains two polymers amylose, which is essentially linear, composed of anhydroglucose units linked by α(1-4) glucosidic bonds, and amylopectin, a branched polymer composed of anhydroglucose units with α(1-4) and α(1-6) glucosidic bonds.

Starch products originating from a range of plant sources including maize, tapioca, wheat, potato and rice are of great importance in the food industry. However, in many food processing applications, these starches are unacceptable due to poor process tolerance and stability, as well as poor functionality. In this regard acid, heat, shear and freeze thaw stability are important processing requirements for starch in the food industry. Functional requirements include taste, texture, viscosity and opacity.

To address the above problems, modifications of starch, which include chemical, physical and enzymatic modification are carried out. These modifications are not as effective in starch from some plant types. For example, chemically modified (cross-linked) wheat starch has poor freeze thaw and acid stability and low viscosity and may impart an unsuitable texture in many processed food applications.

In contrast to modified wheat starch and other starches which have limited food processing applications when modified, modified waxy maize starch can be used across a broad range of food applications including bottled, canned, shelf stable, unrefrigerated and frozen foods.

Some examples of common modifications to waxy maize starches are cross-linking, with phosphorus oxychloride or sodium trimetaphosphate, and cross-linking and substitution. Substitution may be through a process of acetylation (with acetic anhydride) or hydroxypropylation (with propylene oxide). Substitution modification of the waxy maize starch improves freeze-thaw stability, texture (body and creaminess) and lowers its gelatinization temperature. Hydroxypropylation has a greater effect on these characteristics than acetylation but is a more expensive process which adds to the cost of producing the modified maize starch. Cross-linking and substitution may also be carried out using adipic acid and acetic anhydride and this modification is used in many processed food products.

Though chemically modified waxy maize starch finds wide application in the food industry, it has limitations with respect to texture and process stability. Hydroxypropylation as referred to above helps to improve process stability but is an expensive treatment. Waxy maize starch also has a relatively strong cereal flavour which is noticeable in many food products and which can considerably mask natural flavours. Unfortunately, modified waxy maize starch is unsuitable for use in applications where a relatively mild flavour is sought.

A further approach is starch having a very bland taste, such as tapioca starch. However, these starches have very poor processing and freeze thaw stability as mentioned above. Modification to improve processing and freeze thaw stability, such as cross-linking and substitution of the tapioca starch does not give a sufficient level of shear and acid stability necessary in many food processing applications, although it does find use in ready-to-eat refrigerated custards and other dairy applications.

Gums, for example vegetable gums, have also been used in an attempt to deal with some of the above problems of starches, for example to increase viscosity and/or add body to foods. However, gums introduced may contribute unpleasant mouthfeel to products, sometimes referred to as “gummyness” and do not ameliorate functionality and stability problems of starches, such as chemically cross-linked and substituted waxy maize starch referred to above. They also add to the cost of the finished product.

There remains a distinct need for a starch that has the necessary flavour, texture, low temperature storage and stability required for many food processing applications.

### SUMMARY OF THE INVENTION

Surprisingly, it has been found that modification of waxy wheat starch, such as chemical cross-linking the starch with a cross-linking agent, and optionally substituting hydroxyl groups in the starch, provides a starch product with excellent freeze-thaw stability, processing stability, texture and flavour which is in direct contrast to that of modified non-waxy wheat starch. Moreover, the processing and functional advantage of modified waxy wheat starch are markedly superior to those of modified waxy maize starch According to one aspect, the present invention provides a chemically cross-linked and/or substituted modified waxy wheat starch, which is suitable for use in the food industry.

For the purpose of this invention, waxy wheat starch has less than 10% amylose, preferably less than 1%.

Preferably the modified waxy wheat starch comprises one or more of substituted and cross-linked acetylated distarch adipate waxy wheat starch, sodium trimetaphosphate-distarch phosphate cross-linked waxy wheat starch, phosphorous oxychloride distarch phosphate cross-linked waxy wheat starch, phosphorous oxychloride cross-linked and acetic anhydride esterified waxy wheat starch, or sodium trimetaphosphate cross-linked and acetic anhydride esterified waxy wheat starch. The modified waxy starch may be in the pregelatinised (pre-cooked or dried) form as well as in the form of an uncooked or ungelatinised starch.

Preferably the modified waxy wheat starch is substituted and cross-linked acetylated distarch adipate waxy wheat starch.

The modified waxy wheat starch according to the present invention is stable to acid conditions between pH 3 and at a pH less than 7, resistant to shear degradation, and preferably has a bland flavour, smooth creamy mouthfeel, and/or freeze thaw stability, and/or forms a soft gel after processing. It has further processing advantages in that it has a low hot paste viscosity and high cold viscosity and low pasting temperature, making it suitable for use in heat exchangers.

For the purpose of this invention, hot paste viscosity is the viscosity reached at 95° C., for example as measured using a Brabender Viscoamylograph. Hot paste viscosity is preferably less than 500 BU. For example, at 5% dsb (dry solids basis) and pH=7, waxy wheat starch which has been cross-linked with 0.16% adipic acid and acetylated with acetic anhydride to a degree of substitution of 0.077%, has a hot paste viscosity of 300-500 BU which may be measured for example using a Viscoamylograph fitted with a 350 cmg head. Waxy maize starch, modified under the same conditions, has a hot paste viscosity of 600-900 BU.

Pasting temperature is defined as the temperature at which the viscosity rises, for example as measured by a Brabender Viscoamylograph, from 0 BU to 50 BU. In this invention pasting temperature of the modified waxy wheat starch is less than or equal to 65° C. For example, waxy wheat starch, which has been crosslinked with 0.25% sodium trimetaphosphate and acetylated with acetic anhydride to a degree of substitution of 0.077%, has a pasting temperature of 59-61° C. Waxy wheat starch, which has been crosslinked with 0.16% adipic acid and acetic anhydride to a degree of substitution of 0.069%, has a pasting temperature of 62-64° C. Waxy maize starch, on the other hand, modified under the same conditions has a pasting temperature of 68-70° C. Refrigerated cold viscosity of the modified waxy starch paste is at least 25,000 cps. For example the refrigerated cold paste viscosity of waxy wheat starch cross-linked with 0.25% sodium trimetaphosphate and aceylated with acetic anhydride to a degree of substitution of 0.069% is 25,600 cps, as measured for example by a Brookfield Viscometer compared to 24,000 cps for a similarly modified waxy maize starch.

According to another aspect of the invention there is provided a food product which includes a chemically cross-linked and/or substituted waxy wheat starch. Preferably food products in accordance with this aspect of the invention may be chosen from mass produced food products such as for example pies either containing meat or fruit and suitable for freezing and then thawing before consuming, refrigerated ready-to-eat custards, yoghurts and dairy desserts and puddings and low fat mayonnaise. Other examples of food products contemplated according to this aspect of the invention include sauces and soups which may be for example bottled/canned and retortable, frozen vegetables in sauce, dry mixes such as sauces/gravies, frozen and non-frozen desserts, instant mixes such as marinades, sauces/gravies, fruit pies and fruit pie fillings.

### DETAILED DESCRIPTION OF THE INVENTION

The present invention will be further described from the following examples of preferred but non-limiting embodiments there/of, and the accompanying Figures. With reference to the Figures:

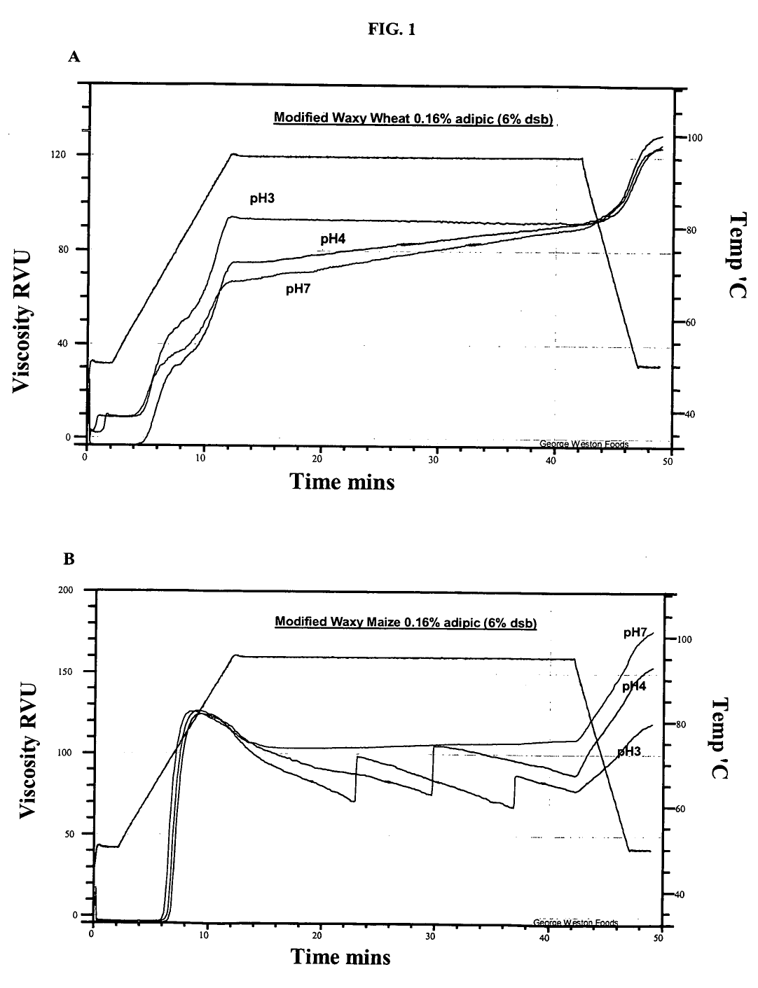

FIG. 1 shows acid stability for the modified waxy wheat (“A”), and modified waxy maize (“B”). The modified waxy wheat is 0.16% adipic acid modification and viscosity is measured at pH 3, 4 and 7. Waxy maize is modified in the same manner and viscosity measured at pH 3, 4 and 7. Viscosity (RVU) is plotted against time in minutes, and against temperature.

As referred to above the present invention provides in one aspect a chemically cross-linked and substituted waxy wheat starch, which starch is suitable for use in the food industry. The modified waxy wheat starch exhibits excellent processing and functional properties. This was unexpected given the poor processing and functional properties of modified wheat starch.

Preferably the modified waxy wheat starch comprises substituted and cross-linked acetylated distarch adipate waxy wheat starch, sodium trimetaphosphate-distarch phosphate cross-linked waxy wheat starch, phosphorous oxychloride distarch phosphate cross-linked waxy wheat starch, phosphorous oxychloride cross-linked and acetic anhydride esterified waxy wheat starch, or sodium trimetaphosphate cross-linked and acetic anhydride esterified waxy wheat starch.

The modified waxy wheat starch according to the present invention has low pasting temperature as previously described, stability to acid between pH 3 and a pH less than 7, resistance to shear degradation, a bland flavour, a smooth and creamy mouthfeel, and/or low hot paste viscosity and/or freeze/thaw stability, and/or forms a soft gel after processing. Preferably the modified waxy wheat starch according to the present invention embodies all of these features.

Modification of waxy wheat starch by chemical cross-linking and/or substitution of starch hydroxyl groups may use any food compatible starch cross-linking and/or substitution agents well known in the art, and may be prepared by well known methods in the art such as in relation to waxy maize starch, for example, as described by: O. B. Wurzburg, U.S. Pat. No. 2,935,510 (1960); Chem. Abstr., 54, 16886 (1960) (National Starch and Chemical Corp.); J. A. Radley, Starch and its Derivatives, Chapman & Hall, Ltd, 1968, (4^{th} ed); Wurzburg, O. B. ed., Modified Starches: Properties and Uses, CRC Press, Boca Raton, Fla. (1986); R. W. Kerr and F. C. Cleveland, Jr., U.S. Pat. No. 2,801,242 (1957): Chem. Abstr., 51, 18666 (1957), (Corn Products Co.); R. W. Kerr and F. C. Cleveland, Jr., U.S. Pat. No. 2,938,901 (1960): Chem. Abstr., 54, 16886 (1960), (Corn Products Co.); R. W. Kerr and F. C. Cleveland, Jr., U.S. Pat. No. 2,852,393(1958): Chem. Abstr., 53, 1797 (1959), (Corn Products Co.); S. M. Chang, C. J. Wang, and C. Y. Lii, Proc. Natl. Sci. Counc. Repub. China, 3, 449 (1979); Chem. Abstr., 92, 148880 (1980); J. A. Radley, 1968, (4^{th} ed), Starch and its Derivatives, Chapman & Hall, Ltd.

Suitable cross-linking agents for starch used in the food industry include, but are not limited to, oxychlorides, such as phosphorous oxychloride, adipic acid, and active phosphates, such as sodium trimetaphosphate.

Examples of chemical substitution agents used in relation to starch include, but are not limited to, esterification with acetic anhydride, and etherification with agents such as propylene oxide. Examples of the extent of cross-linking and substitution levels well known in the art include phosphorous oxychloride −0.01-0.02%, adipic acid −0.05-0.25%, sodium trimetaphosphate −0.05-1%, and acetic anhydride (degree of substitution 0.01-0.08).

Modification of chemical cross-linking and substitution of waxy wheat starch, for example with cross-linking reagent phosphorus oxychloride, adipic acid or sodium trimetaphophosphate and substitution with reagent acetic anhydride provides a modified starch product with enhanced freeze-thaw stability and acid stability. In food technology applications such as fruit pies, refrigerated ready-to-eat custards and low fat mayonnaise (30% and less) modified waxy wheat starch imparts significantly improved textural and flavour characteristics.

Waxy wheat starch is prepared by well known starch extraction processes from waxy wheat flour. Waxy wheat flour is available commercially. Waxy wheat flour is also described in U.S. Pat. No. 6,042,867.

In fruit pie fillings for example, after baking and freezing, using modified waxy wheat the texture “sets-up”, providing a cuttable consistency and full-bodied mouthfeel. Pie fillings incorporating modified waxy maize starch at the same starch concentration have a longer, non-gelled texture which flows out on cutting and imparts a thin texture in the mouth. Consistency or viscosity may be measured using a consistometer instrument (for example a Bostwick Consistometer), for example as described by Bourne, M. C. 1982 Food Texture and Viscosity: Concept and Measurement, Academic Press p 151-64. With this instrument, the viscous food flows down an inclined plane and the distance (in cm) of flow of a material after a set time is measured. The more viscous the food, the shorter the distance travelled. A relative and reproducible measurement is obtained. Consistometer readings are 0.5 cm in 30 seconds for modified waxy maize starch versus 0 cm in 30 seconds for modified waxy wheat starch, a significant difference. Also, the fruit flavour is more pronounced in the modified waxy wheat starch product whereas the waxy maize product masks the fruit flavour. Thus, the true flavour of food products is not masked but rather revealed by the starch of the present invention which is of neutral taste.

In low fat mayonnaise applications for example, modified waxy wheat starch imparts a very creamy mouthfeel, full-bodied texture and spoonable consistency characteristic of full-fat products which consumers find pleasing and appealing. In comparison, the modified waxy maize starch containing product imparts a longer, thinner texture giving a less creamy mouthfeel and pastier appearance.

In refrigerated, ready-to-eat custard and other dairy applications (pourable and pudding types) modified waxy wheat starch again provides a creamier and full-bodied texture and mouthfeel with excellent flavour compared to waxy maize starch (Consistometer readings give 1 cm in 30 secs for modified waxy maize starch containing product against 0.5 cm for the modified waxy wheat starch containing product). In comparison modified waxy maize starch provides a thinner texture and characteristic cereal flavour and modified tapioca starch gives a lighter texture, smooth but not full bodied.

In commercial applications of food products incorporating modified waxy maize starches or modified tapioca starches, these starches often contain added vegetable gums and/or hydroxypropylated starches to improve textural attributes such as creaminess, soft gel set-back characteristics for improved cuttability/spoonability and full-bodied appearance. The use of a modified waxy wheat starch would allow the stated product applications to be formulated with the same processing stability characteristics as modified waxy maize, but without the use or, at least, minimal use of vegetable gums.

Modified waxy wheat starch in accordance with the present invention may be used, for example in pies either containing meat or fruit and suitable for freezing and then thawing before consuming, refrigerated ready-to-eat custards and puddings and low fat mayonnaise. Other examples of food products contemplated according to this aspect of the invention include sauces and soups which may be bottled/canned and retortable; frozen vegetables in sauce; dry mixes such as sauces/gravies; frozen and non-frozen desserts; instant mixes such as marinades, sauces/gravies; fruit pies and fruit pie fillings; and yoghurts and other dairy desserts.

Modified waxy wheat starch is included in food products generally in the range of about 1% to about 10% w/w, more preferably from about 2 to about 5% w/w.

The following are examples of modifications of starch which may be used in accordance with the present invention:

1. Substituted and Cross-Linked—Acetylated Distarch Adipate (1422) (Acetic Acid/Adipic Acid)

### REFERENCES

O. B. Wurzburg, U.S. Pat. No. 2,935,510 (1960); Chem. Abstr., 54, 16886 (1960). (National Starch and Chemical Corp.)
J. A. Radley, Starch and its Derivatives, Chapman & Hall, Ltd, 1968, (4^{th} ed) Wurzburg, O. B. ed., Modified Starches: Properties and Uses, CRC Press, Boca Raton, Fla. (1986)
   2. Cross-Linked with Sodium Trimetaphosphate—Distarch Phophate (1412)

### REFERENCES

R. W. Kerr and F. C. Cleveland, Jr., U.S. Pat. No. 2,801,242 (1957): Chem. Abstr., 51, 18666 (1957), (Corn Products Co.)
R. W. Kerr and F. C. Cleveland, Jr., U.S. Pat. No. 2,938,901 (1960): Chem. Abstr., 54, 16886 (1960), (Corn Products Co.)
R. W. Kerr and F. C. Cleveland, Jr., U.S. Pat. No. 2,852,393(1958): Chem. Abstr., 53, 1797 (1959), (Corn Products Co.)
S. M. Chang, C. J. Wang, and C. Y. Lii, Proc. Natl. Sci. Counc. Repub. China, 3, 449 (1979); Chem. Abstr., 92, 148880 (1980)
J. A. Radley, 1968, (4^{th} ed), Starch and its Derivatives, Chapman & Hall, Ltd

Some other examples of modifications referred to above are as follows:
Cross-linking with phosphorus oxychloride (POCl₃)—similar in properties to cross linking with sodium trimetaphosphate.
Cross-linking with POCl₃ or sodium trimetaphosphate followed by esterification with acetic anhydride—similar in properties to adipic acid/acetic anhydride.
Cross-linking with POCl₃ or Sodium trimetaphosphate and etherification with propylene oxide—provides better processing stability and creamier mouthfeel than other modifications.

Various embodiments of the invention will now be described with reference to the following illustrative but not limiting examples.

### EXAMPLE 1

Starch Extraction

Starch is extracted from waxy wheat flour by methods commonly employed for wheat starch processes including, but not restricted to, the Martin process, the Batter process and Three Phase Decanter process. In the Martin process, a dough is formed by mixing 1 part wheat flour with 0.6 parts water and kneading gently. Starch is then extracted from the dough by adding water with further gentle kneading. The starch liquor produced is passed through a series of screens to remove small gluten particles, bran and fibre. The slurry is then centrifuged to separate starch from water. The starch is then ready for modification.

Adipic Acid/Acetic Anhydride Modification

Prepare a starch slurry 40% dsb. Raise the pH 8-10 with sodium hydroxide solution. Blend 0.05-0.25% adipic acid into 1-6% acetic anhydride. Add adipic/acetic blend to starch slurry, maintaining pH at 8-10 with sodium hydroxide solution. Neutralise to pH 5-5.5 with any permitted food acid. Filter, wash and dry.

Cross Linking with Sodium Trimetaphosphate

Prepare a starch slurry 40% dsb. Raise pH to 7-12 with sodium hydroxide and add 0.1-1% sodium trimetaphosphate. React for sufficient time to give desired viscosity using Brabender Viscoamylograph. Neutralise, filter, wash and dry.

Cross Linking with Phosphorous Oxychloride

Prepare a starch slurry 40% dsb. Raise pH to 8-12 with sodium hydroxide solution. Add 0.01-0.2% phosphorous oxychloride and react to desired viscosity using Brabender viscoamylograph. Neutralise filter wash and dry.

Acetylating with Acetic Anhydride

Prepare a starch slurry 40% dsb. Raise pH 8-10 with sodium hydroxide. Add 1-6% acetic anhydride, maintaining pH 8-10 with sodium hydroxide. Neutralise, filter wash and dry.

Pregelatinisation

For some purposes, a cold water swelling starch is required. This starch is prepared by cooking and drying, by any methods commonly employed for starch processing, so that when added to water, it forms a thick paste. This starch is referred to as a pregelatinised starch. Waxy wheat starch, which has been modified by any of the above techniques can be in the form of an uncooked starch or pregelatinised starch for the purposes of this invention.

### EXAMPLE 2

The following series of test results provide a comparisons between the characteristics of modified waxy wheat starch and those of modified waxy maize starch.

Acid Stability

Modified waxy wheat starch (0.16% adipic acid+acetic anhydride modification) and waxy maize starch modified in the same manner were tested for acid stability according to established procedures as described by Whistler, R. L. et al, 1984 Starch Chemistry and Technology, Academic Press, such as at p 301. The procedure is as follows:

1.0 Test

The stability of starch viscosity under different pH conditions using Rapid Visco Analyser (RVA) is examined.

2.0 Principle

Starch viscosity can be effected by the pH of the solution it is heated in. The Brabender Viscoamylograph and RVA can be used as tools to monitor and compare the viscosity of samples under different pH conditions. The severity of breakdown and setback can be seen.

3.0 Reagents

3.1 0.1 M citric acid solution
3.2 0.2 M dibasic sodium phosphate solution
3.3 Distilled water
   4.0 Apparatus
4.1 Aluminium cup and plastic paddle
4.2 Analytical balance to pan capable of reading 0.01 gm
4.3 RVA—Rapid Visco Analyser
   5.0 Procedure
5.1 Turn on RVA and allow unit to warm up for approx. 30 mins and turn on cooling water
5.2 Test moisture of starch sample by NIR or oven.
5.3 Determine what concentration of starch is desired on a dry solid basis.
5.4 Weight starch into RVA cup and make up to 25 gm using buffer pH 3 or pH 4 or pH 7 as needed.
5.5 Place paddle into cup and disperse starch by stirring paddle around. Slide sample into RVA, ensuring it is securely in place under wire holder.
5.6 Run RVA using appropriate profile
6.0 Calculations

$$RVA calculations e . g . \% Moisture = 12.8 \%$$

$$Weight of starch = \frac{25 g \times 6 \% dsb}{100 - 12.8 \%}$$

Make up to 25 g with tested pH buffer solution.

The results of this test show that the modified waxy wheat starch is stable to acid conditions between pH 3 and a pH less than 7, whereas the modified maize starch is less acid stable. FIG. 1, Part A (modified waxy wheat) and part B (modified waxy maize) show this clearly.

Non-modified waxy maize and wheat starch are not acid stable between pH 3 and pH 7.

Shear Stability

Shear stability was tested according to established procedures for modified waxy wheat starch and modified waxy maize starch. The results demonstrate shear stability of modified waxy wheat which is similar to modified waxy maize and demonstrate the utility of the modified waxy wheat starch in food applications.

TABLE 1
Ratio of sheared:unsheared viscosities -Acetylated adipates

| | Commercial | modified | modified | modified | modified | modified |
|---|---|---|---|---|---|---|
| | Modified | waxy maize | waxy maize | waxy wheat | waxy wheat | waxy wheat |
| | Waxy Maize | (0.13%)* | (0.16%)* | (0.08%)* | (0.13%)* | (0.16%)* |
| pH 7 | 0.710 | 0.741 | 0.700 | 0.833 | 0.929 | 0.734 |
| pH 4 | 0.941 | 0.704 | 0.854 | 0.733 | 0.893 | 0.597 |
| pH 3 | 0.650 | 0.579 | 0.818 | 0.769 | 0.769 | 0.917 |

*indicates percentage of adipic acid used in chemical modification

TABLE 2
Ratio of sheared:unsheared viscosities- STMP cross-linked

| | modified waxy maize | modified waxy wheat |
|---|---|---|
| | (0.25% STMP) | (0.25% STMP) |
| pH 7 | 1.444 | 1.2 |
| pH 4 | 0.982 | 0.667 |
| pH 3 | 0.667 | 0.563 |

Freeze Thaw Stability

Modified waxy wheat (acetylated adipate) showed 30% moisture loss over 5 freeze thaw cycles compared to 40% for the equivalent modification for waxy maize. The wheat was still soft in texture while the maize had become fibrous.

Hence, freeze thaw stability is enhanced for the waxy wheat by reduced water loss and improved texture.

Paste Consistency

The modified waxy wheat starch forms a soft gel when cooked in an aqueous or other fluid medium, for example at 5% w/v compared to modified waxy maize which form a paste. The formation of a soft gel is important in imparting set-up, to provide a full-bodied mouthfeel and more viscous consistency. Consistometer readings as shown subsequently demonstrate the useful viscous consistency.

Tests on substituted and cross-linked acetylated distarch adipate waxy wheat starch, sodium trimetaphosphate-distarch phosphate cross-linked waxy wheat starch, phosphorous oxychloride cross-linked waxy wheat starch, phosphorous oxychloride cross-linked and acetic anhydride esterified waxy wheat starch, or sodium trimetaphosphate cross-linked and acetic anhydride esterified waxy wheat starch are performed in the same manner as above, with expected results in keeping with those given above.

### EXAMPLE 3

Food Product Analysis

Conventional pie fillings were prepared, one batch containing modified waxy wheat starch as described at the beginning of Example 2, and the other batch containing likewise modified waxy maize starch.

Apple Pie Filling (Cook-Up)

(For fresh or Frozen Applications)

| Ingredients | % |
|---|---|
| Starch | 3.9 |
| Sugar | 9.0 |
| Lemon Juice | 2.5 |
| Water | 18.1 |
| Apple Diced (Canned/Blanched) | 50.0 |
| Apple Puree (Canned/Blanched) | 16.50 |
| Total | 100 |

Procedure
1. Blend starch, half of the sugar and all of the water. Under continuous agitation, heat mixture to 90° C. and hold for approximately 5 minutes (or until thick). Remove from heat, add remainder of sugar and combine well; cool. Add lemon juice
2. Fold apple through starch mixture. Fill pie casing. Cover with pastry if desired.
3. Bake pies at 180° C. until golden brown. Freeze if required.
4. To reheat, place frozen pie in oven at 180° C. for approximately 45 minutes.
   Consistometer readings taken with a Bostwick Consistometer were carried out in accordance with the procedure of Bourne, M. C. 1982 Food Texture and Viscosity: Concept and Measurement, Academic Press p 151-64. Consistiometer readings were 0.5 cm in 30 seconds for the modified waxy maize starch, compared with 0 cm in 30 seconds for the modified waxy wheat starch filling.

In refrigerated ready-to-eat custard applications (pouring pudding types) a similar test was carried out testing a custard mixture containing modified waxy wheat starch and an identical custard mixture except that it contained modified waxy maize starch.

Chocolate Custard

| Ingredients | g | % |
|---|---|---|
| Whole Milk | 338 | 67.4 |
| Skim Milk | 97.5 | 19.4 |
| Sugar | 40 | 8 |
| Starch | 17.5 | 3.5 |
| Cocoa Powder | 7.5 | 1.5 |
| Total | 501.5 | |

Procedure
1. Combine all ingredients and mix well.
2. Stirring continuously, heat mixture to 90° C. and hold for 10 minutes.
3. Refrigerate and use as required.

Consistometer readings were again carried out and gave a value of 1 cm in 30 seconds for the modified waxy maize starch custard compared with 0.5 cm for modified waxy wheat starch containing custard.

The modified waxy maize starch gave a thinner custard texture, and imparted a characteristic cereal flavour.

Set-up was also measured utilising a stringiness determination according to the procedure of Reddy, I. and Seib, P. A., Modified Waxy Wheat Starch, Journal of Cereal Science 31 (2000) 25-39. This objective test is based on the concept that a “stringy” paste will cling to a probe longer upon removal of the probe compared with a short-textured paste. Stringiness determination measurements also confirmed the significant and unexpected set-up of the products containing modified waxy wheat starch.

Sensory Analysis

Waxy wheat starch was demonstrated by sensory analysis to impart a blander flavour, creamier texture and fuller mouthfeel when used in conventional starch containing foods, such as custards and low fat mayonnaise products where modified waxy maize starch is the standard starch utilised. Structured scaling, unstructured scaling and ratio scaling tests were carried out according to Poste et al, Laboratory methods for sensory analysis of foods, Research Branch Agriculture Canada Publication 1864/E 1991.

With structured scaling, panelists are provided with a scale showing several degrees of intensity of flavour, perceived creaminess and mouthfeel. In unstructured scaling tests, panelists record the evaluation of the sensory property on a horizontal line at the point that best reflects their perception of the magnitude thereof. In ratio scaling tests, panelists estimate the order of magnitude of different properties by assigning a relative value. In these analyses, the modified waxy wheat containing product was determined to have a much creamier texture and full mouthfeel compared with the comparative modified waxy maize starch containing product. The flavour of the product was also stronger, not masked by the flavour of the starch, for example the apple flavour in apple pies was considered much stronger when modified wheat starch was used.

Although several preferred embodiments have been described in detail, it should be understood that various changes, substitutions, and alterations can be made herein by one ordinarily skilled in the art without departing from the spirit or scope of the present invention.

1. A chemically cross-linked and/or substituted modified waxy wheat starch which is substituted and cross-linked acetylated distarch adipate waxy wheat starch.

2. A food product which includes the modified waxy wheat starch according to claim 1.

3. The food product according to claim 2, wherein the food product is a pie either containing meat or fruit and suitable for freezing and then thawing before consuming.

4. The food product according to claim 2, wherein the food product is a refrigerated ready-to-eat custard.

5. The food product according to claim 2, wherein the food product is a low fat mayonnaise having 30% or less fat content.

6. The food product according to claim 2, wherein the food product is a sauce, soup, frozen vegetables in sauce, dry mix, frozen and non-frozen dessert, instant mix, gravy, fruit pie, fruit pie filling, yoghurt or a dairy dessert.

7. The food product according to claim 6, wherein the sauce or soup is bottled, canned or retortable.

8. The food product according to claim 6, wherein the dry mix is in the form of a sauce or gravy.

9. The food product according to claim 6, wherein the instant mix is in the form of a gravy.

10. The food product according to claim 2, wherein said modified waxy wheat starch is substituted and cross-linked acetylated distarch adipate waxy wheat starch.

11. The food product according to claim 2, wherein said modified waxy wheat starch is stable to acid conditions between pH 3 and at a pH less than 7, and is resistant to shear degradation.

12. The food product according to claim 2, wherein said modified waxy wheat starch is freeze-thaw stable.

13. The food product according to claim 2, wherein said modified waxy starch has a smooth creamy mouthfeel.

14. The food product according to claim 2, wherein said modified waxy wheat starch forms a soft gel when cooked with water.

15. The food product according to claim 2, wherein said modified waxy wheat starch is in a pregelatinised form.

16. The food product according to claim 2, wherein said modified waxy wheat starch has a low pasting temperature of less than 65° C.

17. The food product according to claim 2, wherein said modified waxy wheat starch has a low hot paste viscosity which is less than or equal to 500 BU and a high cold paste viscosity of at least 25,000 cps.

18. The food product according to claim 2, wherein said food product is a fruit pie filling or a fruit pie containing said filling, and wherein the filling has a consistometer value of 0 cm in 30 seconds, so as to provide a cuttable consistancy.

19. The food product according to claim 6, wherein said food product has a full-bodied mouthfeel.

20. The food product according to claim 19, wherein said food product has a pronounced fruit flavor compared to a modified waxy maize containing food product.

21. The food product according to claim 4 or 5, wherein said food product has a creamy mouthfeel, full bodied texture and spoonable consistency characteristic of a full fat product.

22. The food product according to claim 6, wherein said food product comprises a dairy dessert, and said food product has a consistomer value of 0.5 cm in 30 seconds.
